(19) United States
(12) Patent Application Publication
(10) Pub. No.: US 2009/0195511 A1
(43) Pub. Date: Aug. 6, 2009

(54) Touch sensitive display employing an SOI substrate and integrated sensing circuitry

(76) Inventors: Jeffrey Scott Cites, Horseheads, NY (US); David Francis Dawson-Elli, Elmira, NY (US); Eric John Mozdy, Horseheads, NY (US); Carlo Anthony Kosik Williams, Painted Post, NY (US)

Correspondence Address: CORNING INCORPORATED, SP-TI-3-1, CORNING, NY, 14831, US

(21) Appl. No.: 12/012,564

(22) Filed: Feb. 4, 2008

(51) Int. Cl. G06F 3/041

(52) U.S. Cl. 345/173

(57) ABSTRACT

Methods and apparatus for producing a touch sensitive LCD employing a semiconductor on glass (SiOG) structure provide for: a glass or glass-ceramic substrate; a single crystal semiconductor layer bonded to the glass or glass-ceramic substrate; display circuitry including a plurality of thin-film transistors disposed on the single crystal semiconductor layer and forming a matrix of display pixels; display control circuitry operable to drive the display circuitry to produce viewable images; and sensing circuitry operable to detect electrical characteristic changes in one or more of the single crystal semiconductor layer and the display circuitry, the electrical characteristic changes resulting from user touch events.

### BACKGROUND

The present invention relates to touch sensitive displays, such as liquid crystal displays, organic light emitting diode displays, etc., employing a semiconductor-on-insulator (SOI) structure and integrated touch sensing circuitry.

The display market is eager for displays that also offer touch sensing capability—and the market size for displays with touch functionality is expected to grow tremendously in the coming years. As a result, many companies have researched a variety of sensing techniques, including resistive, projected capacitive, infrared, load cell, etc. While many of these techniques result in reasonable touch capability, each technique carries some performance disadvantage for specific applications, and nearly all result in significant added cost to the manufacture of each display.

In terms of performance, the basic metrics for touch sensitive displays are the accurate sensing of a touch event and the determination of the precise location of the touch event on the display surface. Many secondary attributes are becoming important for added functionality, including flexibility in sensing various touching implements beyond the human finger, such as a pen, stylus, credit card edge, etc., the ability to sense multiple, simultaneous touch events, location resolution, and the ability to distinguish false touches (hovering, or environmental disturbances). When such additional criteria are taken into consideration, only a few sensor technologies stand out, and these generally measure the actual force of the touch event.

In order to overcome some of the added cost while focusing on preferred attributes, many panel makers have also been investigating novel touch sensing technologies, often referred to as “embedded” or “integrated” touch, where touch capability is accomplished by incorporating additional components and/or circuitry into the display itself, as opposed to placing separate touch panel sensing element(s) on top of the display. This approach can also have some performance benefit such as limiting the number of surfaces (usually glass) between the display pixel and the outside environment that would otherwise reduce the pixel intensity and cause undesired reflections. In some cases, the display manufacturer can even obtain added functionality, such as the use of in-pixel photosensors to detect touch events that can also be used to scan images into the display.

T. Tanaka et al, “Entry of Data and Command for an LCD by Direct Touch: An Integrated LCD Panel”, SID 1986 discloses an arrangement which provides a touch sensor function in a passive matrix display. In this arrangement, any capacitance change of a liquid crystal layer caused by a touch input is detected using the passive matrix scan and data lines. However, performance is limited and complexity and cost are increased by having to provide suitable display driver and sensor circuits off the panel forming the display.

U.S. Pat. No. 6,028,581 discloses an active matrix liquid crystal display having an integrated sensor arrangement. In this arrangement, photodiodes are integrated at each pixel and are arranged to detect touch input, for example by a stylus, or to detect an image formed on the display. However, such an arrangement requires changes to the active matrix which substantially reduce the fill-factor and hence the image quality of the display.

JP 5-250093 discloses an active matrix liquid crystal display having an arrangement for detecting the coordinates of an input pen when in contact with the display. The input pen generates a fixed voltage, altering the data on the signal electrode lines with which it is contact. The differences between the altered signal and the input data are used to determine the point of contact. The signals induced by the input pen are registered in the addressing matrix.

Another approach to integrated touch capability for LCD displays uses the dielectric constant change in the liquid crystal material when under pressure from the touch event. Details as to this approach are found in U.S. 2004/0227743. External pressure, e.g., from a user's finger, causes alignment of the LC material under the glass surface, and this can be measured as a capacitance change in the display driving circuitry. Unfortunately, this approach to touch sensing has yet to be commercialized because, among other reasons, low signal-to-noise-ratio (SNR), non-uniformity of the semiconductor backplane (which is amorphous or poly-silicon, a-Si or p-Si), and relatively low carrier mobility of the transistors of the backplane. The low SNR and low mobility also have a significant effect on the rate at which the touch events may be detected. Indeed, the LCD display is used in a multiplexed fashion, for display of information to each pixel (screen refresh) and for touch detection. Low SNR and low mobility translate into relatively slow display and/or detection rates, which places constraints on both the touch sensing capability and picture quality of the display. As a result, circuit designers have been forced to compromise one or both of these functions, and have reported reduced touch scan rates and/or lower density of touch sensor elements (i.e., not sensing touch in every pixel) in order to save on time and complexity.

### SUMMARY

In accordance with one or more embodiments of the present invention, a single crystal film on glass (or glass-ceramic) backplane is employed for an embedded/integrated touch display. Touch sensing capability is accomplished by using sense circuitry to detect changes in electrical characteristics of circuitry within the display itself, such as dielectric constant changes in liquid crystal material, dielectric constant changes in the single crystal film itself, and/or electrical characteristic changes in other portions of the integrated display circuitry.

The present invention capitalizes on the electrical properties provided by a backplane formed from a single crystal semiconductor layer on a glass or glass-ceramic substrate. The single crystal semiconductor layer provides a carrier mobility and uniformity that results in higher frequency of operation, shorter processing times, better image quality, and more complete touch-sensing function. The stable, high mobility, and uniform semiconductor characteristics of the single-crystal semiconductor film enables panel makers to overcome the shortcomings of prior art touch-capable displays manufactured on amorphous silicon or poly-silicon backplanes.

For example, the high mobility of the single crystal semiconductor layer material can support driving frequencies exceeding those of amorphous silicon or poly-silicon, which permits faster multiplexing of display and touch sensing signals, and reduction or elimination of design compromises in display quality and touch sensing capabilities. The high uniformity of the single crystal semiconductor layer eliminates the typical device-to-device non-uniformity seen in circuits formed with either amorphous silicon or poly-silicon. As a result, drift and noise problems of prior art integrated touch sensors are greatly reduced or eliminated using the single crystal film on glass (or glass-ceramic) backplane of the present invention—thus, panel makers can forego the use of special uniformity compensation circuit elements. In addition, the prior art processing steps associated with the crystallization of amorphous or poly-silicon may be eliminated when the single crystal layer on glass (or glass-ceramic) backplane of the present invention is employed, which simplifies the manufacture of the display, including the circuit design and fabrication for the embedded touch sensors.

Further advantages flow from the excellent electrical characteristics of the single crystal layer of the backplane, such as that the display exhibits lower-noise amplification, which means that simplified (and less costly) sensing circuit designs may be employed, and/or improved signal to noise characteristics result in the detection of touch events.

In accordance with one or more embodiments of the present invention, a display includes: a glass or glass-ceramic substrate; a single crystal semiconductor layer bonded to the glass or glass-ceramic substrate; display circuitry including a plurality of thin-film transistors disposed on the single crystal semiconductor layer and forming a matrix of display pixels; display control circuitry operable to drive the display circuitry to produce viewable images; and sensing circuitry operable to detect electrical characteristic changes in one or more of the single crystal semiconductor layer and the display circuitry, the electrical characteristic changes resulting from user touch events.

The display circuitry may include a plurality of liquid crystals associated with the display pixels and operable to produce the images. Alternatively, the display circuitry may include a different type, such as an OLED. In the case of an LCD, the electrical characteristic changes resulting from user touch events may include dielectric constant changes in one or more of the liquid crystals.

Alternatively, the electrical characteristic changes resulting from user touch events may include dielectric constant changes in the single crystal semiconductor layer, and/or changes in performance characteristics in the matrix of display pixels.

The single crystal semiconductor layer should exhibit high uniformity with substantially no grain boundaries. For example, the single crystal semiconductor layer may exhibit an n-type carrier mobility of greater than about 400 cm²/V·s, greater than about 450 cm²/V·s, and/or between about 450-600 cm²/V·s. Alternatively, for p-type material, the single crystal semiconductor layer may exhibit a p-type carrier mobility of greater than about 160 cm²/V·s, or greater than about 200 cm²/V·s.

Other aspects, features, advantages, etc. will become apparent to one skilled in the art when the description of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram illustrating the structure of a touch sensitive display employing thin film transistor (TFT) technology on an SOI backplane in accordance with one or more embodiments of the present invention;

FIG. 2 is a schematic diagram suitable for implementing portions of the touch sensitive display of FIG. 1;

FIG. 3 is a timing diagram illustrating relationships among some signals of the circuit of FIG. 2; and

FIGS. 4-8 are block diagrams illustrating intermediate structures formed using processes of the present invention to produce a base SOI structure on which the display of FIG. 1 may be formed.

### DETAILED DESCRIPTION

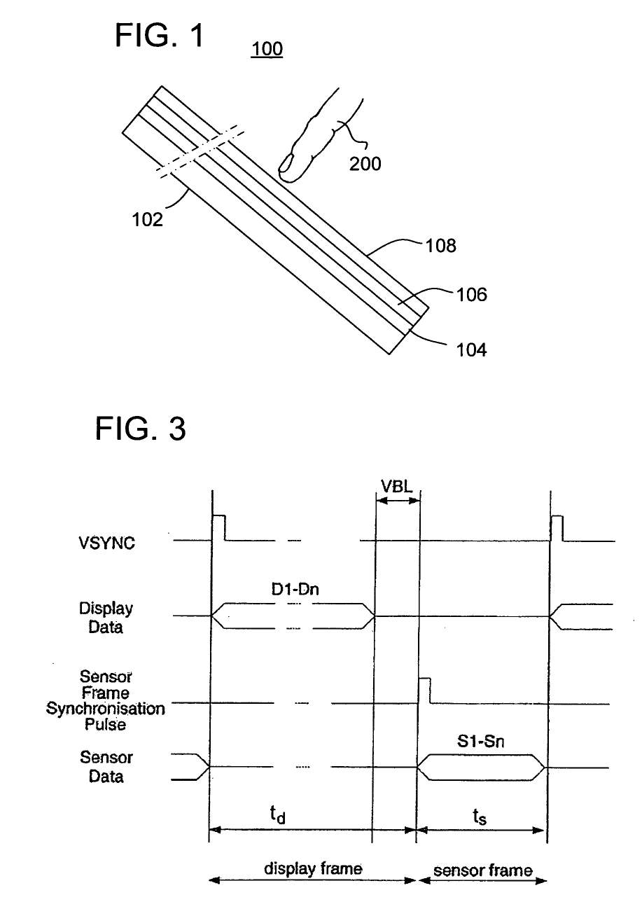

With reference to the drawings, wherein like numerals indicate like elements, there is shown in FIG. 1 a display 100 formed using an SOI backplane structure (specifically an SOG structure) in accordance with one or more embodiments of the present invention. The display 100 is touch-sensitive in that a user may not only view images thereon, but can also input information via the display 100 by touching the display using a finger 200 or other touching implement, such as a pen, stylus, credit card edge, etc. As will be discussed in more detail below, the display 100 employs a touch sensing technology in which the sensing electronics are “embedded” or “integrated” (i.e., enclosed) within the display 100 itself, as opposed to separate touch sensing elements being located on top of the display 100.

The display 100 includes a glass or glass-ceramic substrate 102, a single crystal semiconductor layer 104 bonded to the glass or glass-ceramic substrate 102, display circuitry 106 including a plurality of thin-film transistors (TFTs) disposed on the single crystal semiconductor layer 104 and forming a matrix of display pixels, and a cover layer 108, such as a glass or polymer layer to protect and encapsulate the electronics within the display 100. Not shown are display control circuitry operable to drive the display circuitry 106 to produce viewable images; and sensing circuitry operable to detect electrical characteristic changes in any part of the display 100, where the electrical characteristic changes result from user touch events.

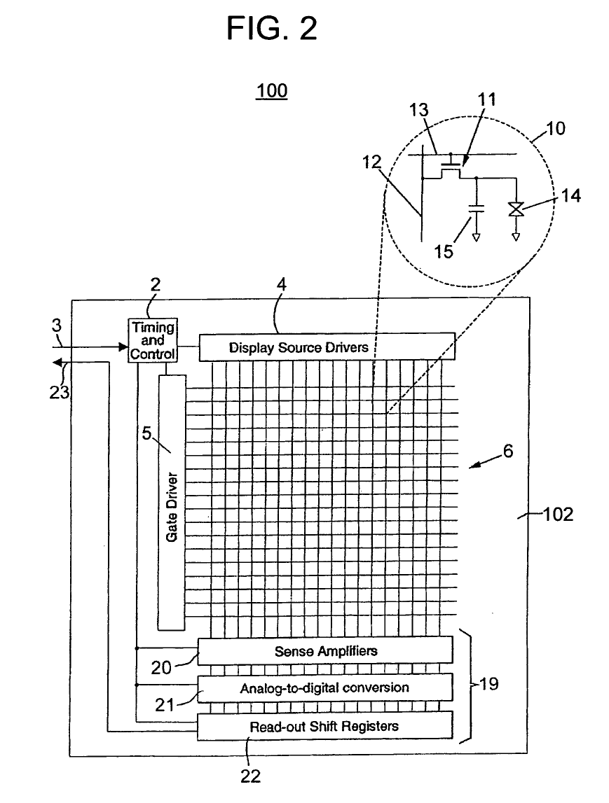

In one or more embodiments, the display circuitry 106 may constitute an active matrix LCD, which will be the primary exemplary embodiment discussed herein. It is understood, however, that the display circuitry 106 may constitute other types of technologies, such as organic LEDs, etc., without departing from the scope of the present invention. With reference to FIG. 2, in an embodiment in which the display circuitry 106 constitutes an active matrix LCD, the circuitry thereof is formed on the glass or glass-ceramic substrate 102. The display control circuitry includes a timing and control circuit 2 receiving an input 3, comprising timing and control signals together with image data to be displayed. The control circuit 2 supplies the appropriate signals to a data signal generator implemented as a display source driver 4 and a scan signal generator in the form of a gate driver 5. The drivers 4 and 5 may be implemented of any suitable type, such as of a standard or conventional type, and thus the implementation details will not be described further herein. The physical layout of the various functional circuitry may be integrated on the SOG backplane 102, 104 with the display source driver 4 being disposed along the upper edge of the matrix 6 and the gate driver 5 being disposed along the left edge of the matrix 6.

The display 100 further comprises sensing circuitry (embedded within the display 100), which is operable to detect electrical characteristic changes resulting from user touch events. The sensing circuitry may include a plurality of sense amplifiers 20, an analog-to-digital conversion block 21, and read-out shift registers 22. The sensing circuitry may be disposed along the bottom edge of the matrix 6.

The display source driver 4 has a plurality of outputs which are connected to, but isolatable from, a plurality of matrix column electrodes which act as column data lines for the active matrix of picture elements (pixels) indicated at 6. The outputs of the display source driver 4 may, for example, only be connected to the data lines when the driver is enabled by the control circuit 2. The column electrodes extend throughout the y-axis dimension of the active matrix 6 and each is connected to the data inputs of a respective column of pixels. Similarly, the gate driver 5 has a plurality of outputs connected to row electrodes which extend throughout the x-axis dimension of the matrix 6. Each row electrode acts as a row scan line and is connected to scan inputs of the pixels of the respective row.

One of the pixels is illustrated in more detail at 10 and is of an active matrix liquid crystal type. The pixel 10 comprises an electronic switch 11 in the form of a thin-film-transistor TFT 11 disposed on the single crystal semiconductor layer 104. The source of the TFT 11 is connected to the column electrode 12, the gate is connected to the row electrode 13, and the drain is connected to a liquid crystal pixel image generating element 14 and a parallel storage capacitor 15.

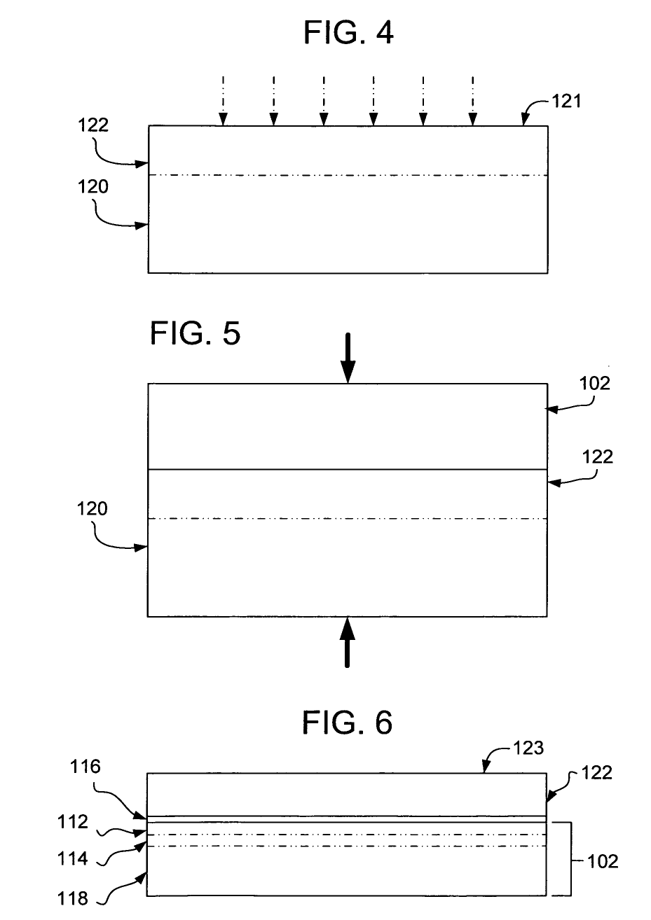

Image data for display are supplied by any suitable source to the input 3 of the display circuitry and are displayed by the active matrix 6 in accordance with the operation of the drivers 4 and 5. For example, with reference to FIG. 3, in an embodiment where the display is refreshed row-by-row, pixel image data are supplied serially as image frames with a frame synchronization pulse VSYNC indicating the-start of each frame refresh cycle. Rows of pixel image data enter one after the other in the display source driver 4 and a scan signal is supplied to the appropriate row electrode for enabling the image data to be stored in the appropriate row of pixels. Thus, the pixel rows of the matrix 6 are refreshed a row at a time with the gate driver 5 usually supplying scan signals a row at a time starting at the top row and finishing at the bottom row when a frame refresh cycle has been completed.

In the mode of operation illustrated in FIG. 3, each display frame occupies a time t_{d} and includes a refresh part during which the display data are used to refresh the matrix 6 of pixels a row at a time followed by a vertical blanking period VBL. As will be discussed later herein, at the end of the display frame period, a sensor frame synchronization pulse is supplied to initiate a sensor frame of period tₛ forming a sense phase of the display 100. The above cycle of operation is repeated starting with the VSYNC pulse which initiates refreshing of the display 100 with the next frame of display data. The display frame time t_{d} may or may not be equal to the sensor frame time tₛ. Although FIG. 3 illustrates the sensor frame tₛ occurring after the vertical blanking period VBL of the preceding display frame, the sensor frame may alternatively occur within the blanking period of the display frame.

Referring to FIG. 2, when the pixel 10 is being refreshed during the display phase, the gate driver 5 supplies a scan signal to the row electrode 13, which turns on the TFT 11. The display source driver 4 supplies a voltage representing the desired visual state of the image generating element simultaneously to the column electrode 12 and charge for determining the desired image appearance is transferred from the column electrode 12 to the storage capacitor 15 and to the image generating liquid crystal element 14, which also acts as a capacitor. The voltage across the element 14 causes the display of the desired image grey level through the cover layer 108. The liquid crystal pixel image generating element 14 comprises the optically variable region which gives rise to the display action.

The display pixels 10 may be used to sense external stimuli, such as by touching the display 100 using the finger 200 or other touching implement, such as a pen, stylus, credit card edge, etc. For example, each display pixel 10 may be used to detect pressure applied to the cover layer 108 of the display 100. In one mode of operation, the sensing circuitry may be operable to detect electrical characteristic changes in the matrix 6, such as changes in the capacitance of the liquid crystal element 14. Pressing against the cover layer 108 may cause deformation in the liquid crystal structure proximate to the area to which pressure is applied. This deformation causes a detectable change in capacitance of the liquid crystal element 14.

More specifically, the liquid crystal polymer material used in the liquid crystal elements 14 is an anisotropic material and has ordinary and extraordinary components of refractive indices, nₒ and nₑ. Depending on alignment state, the liquid crystal polymer material exhibits differing dielectric constants. The ratio of maximum to minimum dielectric constants may range from about 2.5 to 4.0. The alignment state of the liquid crystal material may be determined by bias conditions applied to both electrodes of the liquid crystal elements 14. When the cover layer 108 is touched, the alignment state of the liquid crystal material changes to a near-isotropic state, on a macroscopic scale. Therefore, a significant capacitance change results from the touch events. The change in capacitance represents a signal generated by and within the matrix 6, itself.

During a sense phase (tₛ), the outputs of the display source driver 4 are isolated from the column electrodes, and the sense amplifiers 20 are controlled, for example enabled, by a control signal from the timing control circuit 2. The gate driver 5 scans the row electrodes one at a time in turn from the top of the matrix 6 to the bottom, such that the inputs of the sense amplifiers 20 are connected to respective column electrodes of the matrix 6. For example, when the row containing the pixel 10 is enabled by the scan signal from the driver 5 on the row electrode 13, the LCD element 14 (including the capacitor 15) is connected to the column electrode 12 by the TFT 11. The outputs of the sense amplifiers are supplied to the analog-to-digital conversion block 21, which converts the analog values from the pixel elements of the matrix 6 (which are sensed by the sense amplifiers 20) to parallel digital outputs. The outputs of the conversion block 21 are connected to the read-out shift registers 22, which convert the parallel output data to serial output data at 23. The shift registers 22 may produce a pure “single bit” serial output or may produce multi-bit serial word outputs.

Any variation of the electrical characteristics of the pixels of the matrix 6 resulting from the external stimulus is detectable by the sense amplifiers 20. The electrical characteristic sensed by the sense amplifiers 20 may be pixel voltage, current, stored charge, capacitance, or may be a combination of any of these. In other modes of operation, other electrical characteristics of the matrix 6 may be sensed, such as the dielectric properties of the semiconductor layer 104 or other portions of the circuit.

All of the rows of the matrix 6 may be scanned for sensor data during the sensor frame. Alternatively, a subset of the rows of the matrix 6 may be scanned during each of a plurality of frames such that the entire matrix 6 is scanned for sensor data over a number of display frames. Sensing only a subset of the rows of the matrix 6 has been a practical necessity in prior art systems since the rate at which sensor data may be obtained is dependent on the display frame rate and the speed at which the pixels of the matrix 6 may be sensed. The prior art (such as U.S. 2004/0227743) recognized that the rate at which the all the pixels of the matrix 6 may be sensed was limited and that a complete scan of the matrix 6 in one frame had an adverse impact on the frame rate (which had to be lengthened) and picture quality. Thus, the prior art essentially required that only a subset of the pixels of the matrix 6 be scanned during each display frame in order to keep the frame rate (and picture quality) high.

In accordance with embodiments of the present invention, the rate at which the pixels of the matrix 6 may be scanned during the sense phase is relatively high—permitting larger portions of the matrix 6 (preferably the entire matrix 6) to be interrogated every frame without reducing the frame rate below accepted levels for high quality imaging. For example, the frame rate should be about 30 frames per second. The present invention capitalizes on the electrical properties provided by the single crystal semiconductor layer 104, such as to increase the mobility of the TFTs 11 of the matrix 6.

The single crystal semiconductor layer 104 provides a carrier mobility and uniformity that results in higher frequency of operation, shorter processing times, better image quality, and more complete touch-sensing function. The stable, high mobility, and uniform semiconductor characteristics of the single-crystal semiconductor layer 104 supports driving frequencies exceeding those of amorphous silicon or poly-silicon, which permits faster multiplexing of display and touch sensing signals, and reduction or elimination of design compromises in display quality and touch sensing capabilities.

The semiconductor material of the layer 104 may be in the form of a substantially single-crystal material. The term “substantially” is used in describing the layer 104 to take account of the fact that semiconductor materials normally contain at least some internal or surface defects either inherently or purposely added, such as lattice defects or a few grain boundaries. The term substantially also reflects the fact that certain dopants may distort or otherwise affect the crystal structure of the semiconductor material.

For the purposes of discussion, it is assumed that the semiconductor layer 104 is formed from silicon. It is understood, however, that the semiconductor material may be a silicon-based semiconductor or any other type of semiconductor, such as, the III-V, II-IV, II-IV-V, etc. classes of semiconductors. Examples of these materials include: silicon (Si), germanium-doped silicon (SiGe), silicon carbide (SiC), germanium (Ge), gallium arsenide (GaAs), GaP, and InP.

As mentioned above, the TFTs of the matrix 6 are formed on the single crystal semiconductor layer 104. To achieve the desired speed of both display and sensing phases discussed above, the TFT material should have fast carrier mobility with high uniformity. The prior art rely on TFTs fabricated from amorphous silicon (a-Si) or polycrystalline silicon (p-Si) films. However the carrier mobility in devices made from these materials is one to five orders of magnitude lower than in bulk silicon, with a variability (non-uniformity) of up to ±30%.

Embodiments of the present invention, however, permit formation of the TFTs on the single crystal semiconductor layer 104, resulting in much higher mobility and uniformity. For example, the single crystal semiconductor layer 104 may exhibit an n-type carrier mobility of greater than about 400 cm²/V·s, greater than about 450 cm²/V·s, and/or between about 450-600 cm²/V·s. Alternatively, the single crystal semiconductor layer 104 may exhibit a p-type carrier mobility of greater than about 160 cm²/V·s, or greater than about 200 cm²/V·s. As to uniformity, the single crystal semiconductor layer 104 exhibits high uniformity with substantially no grain boundaries. These characteristics are advantageous in the display and sensing modes of operation of the display 100.

A significant aspect of the present invention facilitating the aforementioned mobility and uniformity is the formation of the single crystal semiconductor layer 104 on the glass or glass-ceramic substrate 102.

The glass substrate 102 may be formed from an oxide glass or an oxide glass-ceramic. Although not required, the embodiments described herein may include an oxide glass or glass-ceramic exhibiting a strain point of less than about 1,000 degrees C. As is conventional in the glass making art, the strain point is the temperature at which the glass or glass-ceramic has a viscosity of 10^{14.6} poise (10^{13.6} Pa·s). Glass-ceramics are certain glasses which have been subjected to a controlled crystallization process, resulting in a homogeneous crystal/glass material and thereby yielding properties often not obtainable in glass. As between oxide glasses and oxide glass-ceramics, glass-ceramics have the advantage of being more refractory; i.e., compatible with higher temperature processing. The terms glass and glass-ceramic may be used interchangeably herein.

By way of example, the glass substrate 102 may be formed from glass substrates containing alkaline-earth ions, such as, substrates made of CORNING INCORPORATED GLASS COMPOSITION NO. 1737 or CORNING INCORPORATED GLASS COMPOSITION NO. EAGLE 2000®. These glass materials have particular use in, for example, the production of liquid crystal displays.

The glass substrate may have a thickness in the range of about 0.1 mm to about 10 mm, such as in the range of about 0.5 mm to about 3 mm. For some SOG structures, insulating layers having a thickness greater than or equal to about 1 micron are desirable, e.g., to avoid parasitic capacitive effects which arise when standard SOG structures having a silicon/silicon dioxide/silicon configuration are operated at high frequencies. In the past, such thicknesses have been difficult to achieve. In accordance with the present invention, an SOG structure having an insulating layer thicker than about 1 micron is readily achieved by simply using a glass substrate 102 having a thickness that is greater than or equal to about 1 micron. A lower limit on the thickness of the glass substrate 102 may be about 1 micron.

In general, the glass substrate 102 should be thick enough to support the semiconductor layer 104 through the bonding process steps, as well as subsequent processing performed on the SOG structure to produce the TFT 100. Although there is no theoretical upper limit on the thickness of the glass substrate 102, a thickness beyond that needed for the support function or that desired for the ultimate TFT structure 100 might not be advantageous since the greater the thickness of the glass substrate 102, the more difficult it will be to accomplish at least some of the process steps in forming the TFT 100.

The oxide glass or oxide glass-ceramic substrate 102 may be silica-based. Thus, the mole percent of SiO₂ in the oxide glass or oxide glass-ceramic may be greater than 30 mole % and may be greater than 40 mole %. In the case of glass-ceramics, the crystalline phase can be mullite, cordierite, anorthite, spinel, or other crystalline phases known in the art for glass-ceramics. Non-silica-based glasses and glass-ceramics may be used in the practice of one or more embodiments of the invention, but are generally less advantageous because of their higher cost and/or inferior performance characteristics. Similarly, for some applications, e.g., for TFTs using SOG structures employing semiconductor materials that are not silicon-based, glass substrates which are not oxide based, e.g., non-oxide glasses, may be desirable, but are generally not advantageous because of their higher cost. As will be discussed in more detail below, in one or more embodiments, the glass or glass-ceramic substrate 102 is designed to match a coefficient of thermal expansion (CTE) of one or more semiconductor materials (e.g., silicon, germanium, etc.) of the layer 104 that are bonded thereto. The CTE match ensures desirable mechanical properties during heating cycles of the deposition process.

For certain applications, e.g., display applications, the glass or glass-ceramic 102 may be transparent in the visible, near UV, and/or near IR wavelength ranges, e.g., the glass or glass-ceramic 102 may be transparent in the 350 nm to 2 micron wavelength range.

Although the glass substrate 102 may be composed of a single glass or glass-ceramic layer, laminated structures can be used if desired. When laminated structures are used, the layer of the laminate closest to the semiconductor layer 104 may have the properties discussed herein for a glass substrate 102 composed of a single glass or glass-ceramic. Layers farther from the semiconductor layer 104 may also have those properties, but may have relaxed properties because they do not directly interact with the semiconductor layer 104. In the latter case, the glass substrate 102 is considered to have ended when the properties specified for a glass substrate 102 are no longer satisfied.

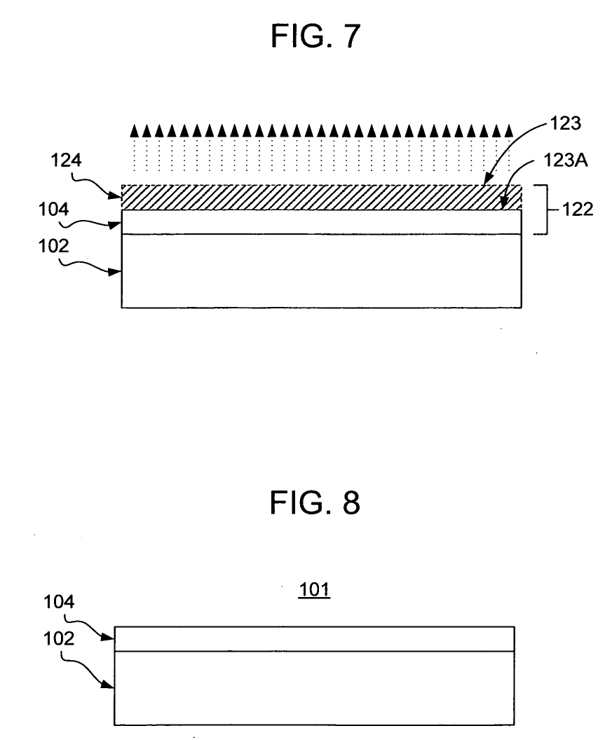

Reference is now made to FIGS. 4-8, which illustrate intermediate structures that may be formed in order to produce a base SOG structure 101 (FIG. 8) on which the display 100 may be formed. Turning first to FIG. 4, an implantation surface 121 of a donor semiconductor wafer 120 is prepared, such as by polishing, cleaning, etc. to produce a relatively flat and uniform implantation surface 121 suitable for bonding to the glass or glass-ceramic substrate 102. For the purposes of discussion, the semiconductor wafer 120 may be a substantially single crystal silicon wafer, although as discussed above any other suitable semiconductor conductor material may be employed.

An exfoliation layer 122 is created by subjecting the implantation surface 121 to one or more ion implantation processes to create a weakened region below the implantation surface 121 of the donor semiconductor wafer 120. Although the embodiments of the present invention are not limited to any particular method of forming the exfoliation layer 122, one suitable method dictates that the implantation surface 121 of the donor semiconductor wafer 120 may be subject to a hydrogen ion implantation process to at least initiate the creation of the exfoliation layer 122 in the donor semiconductor wafer 120. The implantation energy may be adjusted using conventional techniques to achieve a general thickness of the exfoliation layer 122, such as between about 200-500 nm. By way of example, hydrogen ion implantation may be employed, although other ions or multiples thereof may be employed, such as boron+hydrogen, helium+hydrogen, or other ions known in the literature for exfoliation. Again, any other known or hereinafter developed technique suitable for forming the exfoliation layer 122 may be employed without departing from the spirit and scope of the present invention.

The donor semiconductor wafer 120 may be treated to reduce, for example, the hydrogen ion concentration on the implantation surface 121. For example, the donor semiconductor wafer 120 may be washed and cleaned and the implantation donor surface 121 of the exfoliation layer 122 may be subject to mild oxidation. The mild oxidation treatments may include treatment in oxygen plasma, ozone treatments, treatment with hydrogen peroxide, hydrogen peroxide and ammonia, hydrogen peroxide and an acid or a combination of these processes. It is expected that during these treatments hydrogen terminated surface groups oxidize to hydroxyl groups, which in turn also makes the surface of the silicon wafer hydrophilic. The treatment may be carried out at room temperature for the oxygen plasma and at temperature between 25-150° C. for the ammonia or acid treatments.

With reference to FIGS. 5-8 the glass substrate 102 may be bonded to the exfoliation layer 122 using an electrolysis process. A suitable electrolysis bonding process is described in U.S. Pat. No. 7,176,528, the entire disclosure of which is hereby incorporated by reference. Portions of this process are discussed below. In the bonding process, appropriate surface cleaning of the glass substrate 102 (and the exfoliation layer 122 if not done already) may be carried out. Thereafter, the intermediate structures are brought into direct or indirect contact to achieve the arrangement schematically illustrated in FIG. 5. Prior to or after the contact, the structure(s) comprising the donor semiconductor wafer 120, the exfoliation layer 122, and the glass substrate 102 are heated under a differential temperature gradient. The glass substrate 102 may be heated to a higher temperature than the donor semiconductor wafer 120 and exfoliation layer 122. By way of example, the temperature difference between the glass substrate 102 and the donor semiconductor wafer 120 (and the exfoliation later 122) is at least 1 degree C., although the difference may be as high as about 100 to about 150 degrees C. This temperature differential is desirable for a glass having a coefficient of thermal expansion (CTE) matched to that of the donor semiconductor wafer 120 (such as matched to the CTE of silicon) since it facilitates later separation of the exfoliation layer 122 from the semiconductor wafer 120 due to thermal stresses.

Once the temperature differential between the glass substrate 102 and the donor semiconductor wafer 120 is stabilized, mechanical pressure is applied to the intermediate assembly. The pressure range may be between about 1 to about 50 psi. Application of higher pressures, e.g., pressures above 100 psi, might cause breakage of the glass substrate 102.

The glass substrate 102 and the donor semiconductor wafer 120 may be taken to a temperature within about ±150 degrees C. of the strain point of the glass substrate 102.

Next, a voltage is applied across the intermediate assembly, for example with the donor semiconductor wafer 120 at the positive electrode and the glass substrate 102 the negative electrode. The intermediate assembly is held under the above conditions for some time (e.g., approximately 1 hour or less), the voltage is removed and the intermediate assembly is allowed to cool to room temperature.

With reference to FIG. 6, the donor semiconductor wafer 120 and the glass substrate 102 are then separated, which may include some peeling if they have not already become completely free, to obtain a glass substrate 102 with the relatively thin exfoliation layer 122 formed of the semiconductor material of the donor semiconductor layer 120 bonded thereto. The separation may be accomplished via fracture of the exfoliation layer 122 due to thermal stresses. Alternatively or in addition, mechanical stresses such as water jet cutting or chemical etching may be used to facilitate the separation.

The application of the voltage potential causes alkali or alkaline earth ions in the glass substrate 102 to move away from the semiconductor/glass interface further into the glass substrate 102. More particularly, positive ions of the glass substrate 102, including substantially all modifier positive ions, migrate away from the higher voltage potential of the semiconductor/glass interface, forming: (1) a reduced positive ion concentration layer 112 in the glass substrate 102 adjacent the semiconductor/glass interface; and (2) an enhanced positive ion concentration layer 112 of the glass substrate 102 adjacent the reduced positive ion concentration layer 112. This accomplishes a number of functions: (i) an alkali or alkaline earth ion free interface (or layer) 112 is created in the glass substrate 102; (ii) an alkali or alkaline earth ion enhanced interface (or layer) 112 is created in the glass substrate 102; (iii) an oxide layer 116 is created between the exfoliation layer 122 and the glass substrate 102; and (iv) the glass substrate 102 becomes very reactive and bonds to the exfoliation layer 122 strongly with the application of heat at relatively low temperatures.

In the example illustrated in FIG. 6, the intermediate structure resulting from the electrolysis process includes, in order: a bulk glass substrate 118 (in the glass substrate 102); the enhanced alkali or alkaline earth ion layer 114 (in the glass substrate 102); the reduced alkali or alkaline earth ion layer 112 (in the glass substrate 102); the oxide layer 116; and the exfoliation layer 122.

After separation the basic resulting structure of FIG. 6 includes the glass substrate 102 and the exfoliation layer 122 of semiconductor material bonded thereto. The cleaved surface 123 of the SOI structure just after exfoliation may exhibit excessive surface roughness, excessive silicon layer thickness, and implantation damage of the silicon layer. In some cases, the damaged silicon layer may be on the order of about 50-150 nm in thickness. In addition, depending on the implantation energy and implantation time, the thickness of the exfoliation layer 122 may be on the order of about 200-500 nm. The final thickness of the semiconductor layer 104 should be between about 5-50 nm, such as 10 nm.

Accordingly, with reference to FIG. 7, the cleaved surface 123 is subject to post processing, which may include subjecting the cleaved surface 123 to etching, polishing, and/or thinning, etc., indicated by the arrows showing removal of material. The post process is intended to remove material 124 of the exfoliation layer 122, leaving the semiconductor layer 104. The characteristics of the post process are such that the base SOG structure 101 (FIG. 8) includes the single crystal semiconductor layer 104 of about 5-50 nm thickness, particularly about 10 nm thickness. Additionally or alternatively, the semiconductor layer 104 may exhibit a surface roughness of less than about 25 Angstroms RMS, at least prior to formation of the TFT components.

The display circuitry 106 including the plurality of TFTs of the matrix 6, the drivers 4, 5, and the sensing circuitry, etc. are disposed on the single crystal semiconductor layer 104 using known deposition techniques. The display circuitry deposition will include the selection and implementation of the display type, such a LCD, OLED, etc. Thereafter, the cover layer 108 is applied and the display 100 is sealed.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A display, comprising:
a glass or glass-ceramic substrate;
a single crystal semiconductor layer bonded to the glass or glass-ceramic substrate;
display circuitry including a plurality of thin-film transistors disposed on the single crystal semiconductor layer and forming a matrix of display pixels;
display control circuitry operable to drive the display circuitry to produce viewable images; and
sensing circuitry operable to detect electrical characteristic changes in one or more of the single crystal semiconductor layer and the display circuitry, the electrical characteristic changes resulting from user touch events.

2. The display of claim 1, wherein:
the display circuitry includes a plurality of liquid crystals associated with the display pixels and operable to produce the images; and
the electrical characteristic changes resulting from user touch events include dielectric constant changes in one or more of the liquid crystals.

3. The display of claim 1, wherein the electrical characteristic changes resulting from user touch events include dielectric constant changes in the single crystal semiconductor layer.

4. The display of claim 1, wherein the electrical characteristic changes resulting from user touch events include changes in performance characteristics in the matrix of display pixels.

5. The display of claim 1, wherein the single crystal semiconductor layer exhibits high uniformity with substantially no grain boundaries.

6. The display of claim 1, wherein the single crystal semiconductor layer exhibits an n-type carrier mobility of greater than about 400 cm²/V·s.

7. The display of claim 6, wherein the single crystal semiconductor layer exhibits an n-type carrier mobility of greater than about 450 cm²/V·s.

8. The display of claim 7, wherein the single crystal semiconductor layer exhibits an n-type carrier mobility of between about 450-600 cm²/V·s.

9. The display of claim 1, wherein the single crystal semiconductor layer exhibits a p-type carrier mobility of greater than about 160 cm²/V·s.

10. The display of claim 9, wherein the single crystal semiconductor layer exhibits an p-type carrier mobility of greater than about 200 cm²/V·s.

11. The display of claim 1, wherein the single crystal semiconductor layer is taken from the group consisting of: silicon (Si), germanium-doped silicon (SiGe), silicon carbide (SiC), germanium (Ge), gallium arsenide (GaAs), GaP, and InP.

12. The display of claim 1, wherein:
the glass or glass-ceramic substrate includes, in order, a bulk layer, an enhanced positive ion concentration layer, a reduced positive ion concentration layer, where the enhanced positive ion concentration layer contains substantially all modifier positive ions from the reduced positive ion concentration layer as a result of migration; and
a semiconductor oxide layer is located between the reduced positive ion concentration layer of the substrate and the single crystal semiconductor layer.

13. A display, comprising:
a glass or glass-ceramic substrate;
a single crystal semiconductor layer bonded to the glass or glass-ceramic substrate;
display circuitry including a plurality of thin-film transistors disposed on the single crystal semiconductor layer and forming a matrix of display pixels, and a plurality of liquid crystals associated with the display pixels;
display control circuitry operable to drive the display circuitry to produce viewable images; and
sensing circuitry operable to detect changes in dielectric constant in one or more of the liquid crystals resulting from user touch events,
wherein the single crystal semiconductor layer exhibits an n-type carrier mobility of greater than about 400 cm²/V·s.

14. The display of claim 13, wherein the single crystal semiconductor layer exhibits high uniformity with substantially no grain boundaries.

15. The display of claim 13, wherein the sensing circuitry is operable to detect the changes in dielectric constant in all the liquid crystals of the display circuitry each video frame.

16. The display of claim 13, wherein the single crystal semiconductor layer is taken from the group consisting of: silicon (Si), germanium-doped silicon (SiGe), silicon carbide (SiC), germanium (Ge), gallium arsenide (GaAs), GaP, and InP.
